(19) United States
(12) Patent Application Publication
(10) Pub. No.: US 2002/0165757 A1
(43) Pub. Date: Nov. 7, 2002

(54) Systems, methods and computer program products for comparing business performance

(76) Inventor: Charles Steven Lisser, Santa Monica, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/846,695

(22) Filed: May 1, 2001

(51) Int. Cl. G06F 17/60

(52) U.S. Cl. 705/10

(57) ABSTRACT

Financial and operational performance of business entities is compared by establishing a mathematical frame of reference based on data from a group of entities, determining a rating value based upon the mathematical frame of reference and data for a first of the entities, and presenting the rating value to the first entity. The data for the other entities is not disclosed to the first entity. Means are providing for normalizing the data so that different entities, such as entities selling different brands, can be compared. More specific rating values can be presented. For each entity, performance indicator values can be trended over time and compared to values associated with the other entities, to provide an indication of areas in which the entity can improve its performance and the value of improving the performance.

### FIELD OF THE INVENTION

The present invention pertains to accounting and, more specifically, to systems, methods and computer program products for comparing the performance of businesses and tracking performance indicators of the businesses.

### BACKGROUND OF THE INVENTION

It can be beneficial to compare information from different businesses in order to obtain an understanding of the relative health of the businesses. However, it can be difficult to compare such information in many situations, such as because some businesses desire to keep significant aspects of their information confidential. Another difficulty with comparing information between businesses is that the comparisons can be difficult or even meaningless when comparing between businesses that provide different goods or services, are of significantly different sizes, or are otherwise in different markets.

Accordingly, there is a need for improved systems, methods and computer program products for facilitating comparisons between the information of businesses.

### SUMMARY OF THE INVENTION

In accordance with one aspect of the present invention, performances (e.g., financial and/or operational performance) of business entities are compared by establishing a mathematical frame of reference that is based upon historical data for at least both first and second entities, determining a rating value based upon the mathematical frame of reference and data for the first entity, and presenting the rating value to the first entity, preferably without disclosing the source data for the second entity to the first entity. The usability of the present invention is advantageously enhanced by maintaining anonymity. In one more specific example, the source data for the second entity is also not disclosed to any of the users at the second entity. The system preferably operates similarly for the other entities.

In accordance with one aspect of the present invention, one or more performance indicator values that are related to the rating value are presented in response to a selection made while viewing the rating value.

In accordance with one aspect of the present invention, the mathematical frame of reference used for rating is based upon performance indicator values for entities belonging to a group. For each of the entities, its performance indicator values can be trended over time and compared to values associated with the other entities, to provide an indication of areas in which the entity can improve its performance and the financial value of improving the performance.

In accordance with one aspect of the present invention, a value for a performance indicator is determined for multiple entities using the same formula or equation, with different groups of account balances being the inputs to the equation for different entities. This advantageously allows for the calculated performance values to be meaningfully compared, even if the subentities are different, such as because they sell or service different brands.

In accordance with one aspect of the present invention, the data being compared is selected from the group consisting of sales, expenses, gross profit, net profit, customer feedback data or other operational or marketing data; the frame of reference for the comparing is selected from the group consisting of a frequency distribution, a statistical measure of central tendency, and a spread between lowest and highest data values; and the comparison includes determining a relationship selected from the group consisting of rank, a measure of difference from a statistical measure of central tendency, and an indication of position within a spread.

In accordance with one aspect of the present invention, a screen display includes ranking icons, such as differently colored icons, that are indicative of the ranking (e.g., the ranking icons respectively present the rating values), and trending icons, such as different direction-indicating icons that are indicative of trends.

In accordance with one aspect of the present invention, the operations of the present invention are facilitated by a web site via the Internet.

### BRIEF DESCRIPTION OF THE DRAWINGS

Having thus described the invention in general terms, reference will now be made to the accompanying drawings, wherein:

FIG. 1 is a high level block diagram that diagrammatically illustrates a system for comparing business performance, with the system including multiple business entities, including Macroentities and Subentities, respectively communicating with one another and a web server via intranets and the Internet, in accordance with a first embodiment of the present invention;

FIG. 2 is a block diagram that diagrammatically illustrates high level architecture of computer-readable storage medium(s) of the web server of FIG. 1, including modules of a Web Site, in accordance with the first embodiment of the present invention;

FIG. 3 is a block diagram that diagrammatically illustrates a representative one of the Administrative Data For Macroentity Modules of the Web Site of FIG. 2, in accordance with the first embodiment of the present invention;

FIG. 4 is a block diagram that partially and diagrammatically illustrates the Information For Affiliated Subentities Module of the representative Administrative Data For Macroentity Module of FIG. 3 in greater detail, in accordance with the first embodiment of the present invention;

FIG. 5 is a block diagram that diagrammatically illustrates a representative one of the Administrative Data For Subentity Modules of the Web Site of FIG. 2 in greater detail, in accordance with the first embodiment of the present invention;

FIG. 6 is a block diagram that partially and diagrammatically illustrates a representative one of the Data For Subentity Modules of the Web Site of FIG. 2 in greater detail, in accordance with the first embodiment of the present invention;

FIG. 7 is a block diagram that partially and diagrammatically illustrates the Administrative Data For Aggregate Accounts Module of the Web Site of FIG. 2 in greater detail, in accordance with the first embodiment of the present invention;

FIG. 8 is a block diagram that partially and diagrammatically illustrates the Formula Module of the Web Site of FIG. 2 in greater detail, in accordance with the first embodiment of the present invention;

FIG. 9 is a block diagram that diagrammatically illustrates the Administrative Data For Groups Module of the Web Site of FIG. 2 in greater detail, in accordance with the first embodiment of the present invention;

FIG. 10 is a block diagram that partially and diagrammatically illustrates a Frame Of Reference Value Module of the Value Data For Group Modules of the Web Site of FIG. 2, in accordance with the first embodiment of the present invention;

FIG. 11 is a block diagram that partially and diagrammatically illustrates a representative Rating Value Data Module of the Value Data For Group Modules of the Web Site of FIG. 2, in accordance with the first embodiment of the present invention;

FIG. 12 is a block diagram that partially and diagrammatically illustrates the Screen Display Module of the Web Site of FIG. 2 in greater detail, in accordance with the first embodiment of the present invention;

FIG. 13 is a flow chart illustrating operations performed by a Macroentity of FIG. 1 for collecting Account Balances from multiple Subentities of FIG. 1 and uploading the Account Balances to the Web Site of FIG. 2, in accordance with the first embodiment of the present invention;

FIG. 14 is a flow chart illustrating operations performed by the Web Site of FIG. 2 for populating the Data For Subentity Modules and the Value Data For Group Modules of the Web Site of FIG. 2, in accordance with the first embodiment of the present invention;

FIG. 15 illustrates a portion of a screen display that presents Performance Indicator Values for each of the Subentities that belong to a selected Group, with the screen display also presenting rating indicators and trend indicators for the Subentities of the selected Group, in accordance with a first example of the first embodiment of the present invention;

FIG. 16 illustrates a portion of a screen display that presents multiple rating indicators (e.g., for indicating Rating Values) and trend indicators (e.g., for indicating Trend Values) for each of the Performance Indicators identified by the screen display, in accordance with a second example of the first embodiment of the present invention;

FIG. 17 diagrammatically illustrates a screen display that presents more specific Performance Indicator Values for the same Subentity that is the subject of FIG. 16, with the screen display also presenting rating indicators and trend indicators for each of the presented Performance Indicator Values, in accordance with the second example of the first embodiment of the present invention;

FIG. 18 illustrates a portion of a screen display the presents opportunity information, namely multiple Performance Indicator Values for a Group of the Subentities, with like Performance Indicator Values arranged in each of the rows, one of the columns including Performance Indicator Values for a selected Subentity of the Group, another of the columns including the highest Performance Indicator Values of the Group, and other of the columns indicating the dollar values of the selected Subentity performing at the highest Performance Indicator Values of the Group, in accordance with the second example of the first embodiment of the present invention;

FIG. 19 diagrammatically illustrates a portion of a screen display presenting business plan information, in accordance with the second example of the first embodiment of the present invention; and

FIG. 20 illustrates a portion of a screen display that graphically trends Frame Of Reference Values for a Group of Subentities against the corresponding Performance Indicator Values of a selected Subentity of the Group, in accordance with a third example of the first embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

### High Level Overview

In accordance with a first embodiment of the present invention, an Internet-based system includes a web server that hosts a web site. In accordance with the first embodiment of the present invention, the web site facilitates comparisons between the performance (e.g., financial and/or operational performance) of businesses, and tracks performance indicators of the businesses.

More specifically and according to one aspect, the present invention draws on account data from business Subentities that are within a Group and calculates Performance Indicators therefrom for each of the Subentities, and the Performance Indicators, as opposed to the underlying account data, are compared within the Group. In accordance with one example of the present invention, the identities of Subentities included in the Group are identified to the other members of the Group; however, the specific account data for the members of the Group is not disclosed to the other members. Accordingly, managers of the Subentities can anonymously rate their performance with respect to the other members of the group.

In accordance with another aspect of the present invention, for each Subentity, its Performance Indicators are recast into dollar value opportunities that are framed in comparison to the other members of the Group, and these opportunities can be prioritized to enhance decision-making. In addition, selected Performance Indicators are tracked over time.

According to another aspect of the present invention, the web site provides display screens that graphically illustrate current, historical and comparative information for Subentities, and further provide interactive business planning services.

### Architecture/Data Structures

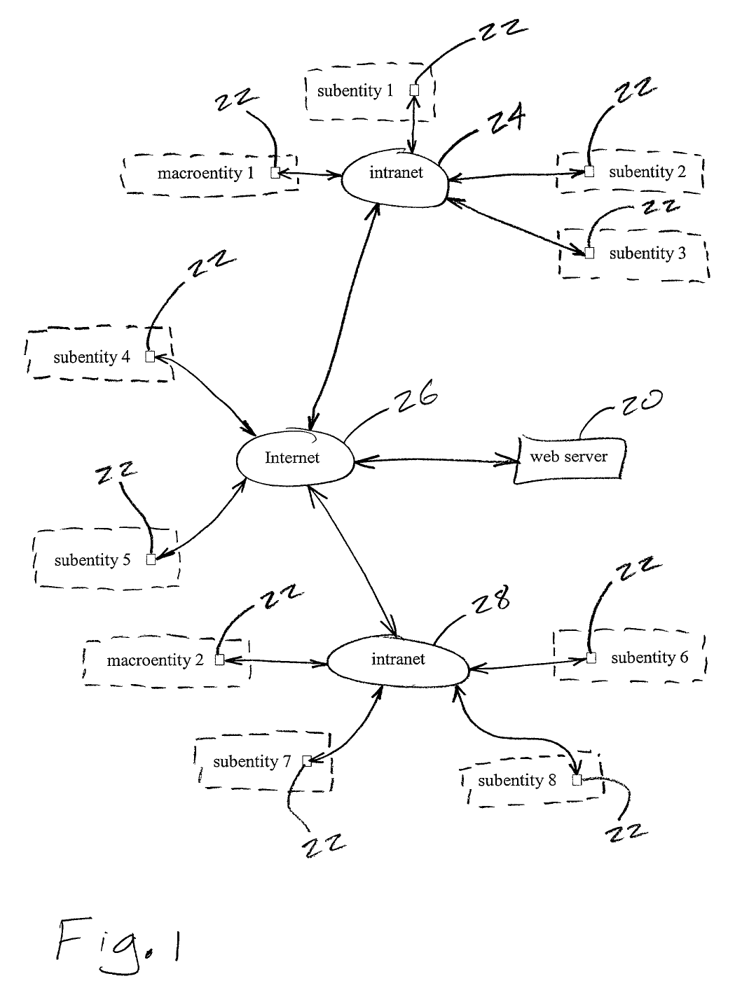

FIG. 1 diagrammatically illustrates an Internet-based system that includes a web server 20 and multiple other computers 22 respectively positioned at Macroentities 1-2 and Subentities 1-8. The computers 22 and web server 20 respectively communicate via intranets 24 and 28 and via the Internet 26, as indicated by the double-ended arrows in FIG. 1. FIG. 1 is representative of a larger system that includes additional Macroentities and Subentities for communicating with the web server 20 via the Internet 26. In accordance with one example of the present invention, each of the Subentities is capable of more directly connecting to the Internet 26, without having to connect to the Internet via an intranet (e.g., intranet 24 or 28).

In accordance with the first embodiment of the present invention, each of the Macroentities (e.g., each of Macroentities 1-2) is a parent corporation, manufacturer, supplier or franchiser, and each of the Subentities (e.g., Subentities 1-3 and Subentities 68, respectively) that is shown connected to the same intranet (e.g., intranet 24 or 28, respectively) with a Macroentity is an affiliate of that Macroentity, such as by being a branch, division or subsidiary thereof, or a dealership, or a franchisee associated therewith. In accordance with the first embodiment of the present invention, it is not required for each Subentity to be affiliated with a Macroentity (e.g., see Subentities 4 and 5) to take advantage of aspects of the present invention that are described herein as being provided for Subentities that are affiliated with a Macroentity. In accordance with the most preferred example of the first embodiment of the present invention, each Macroentity represents a different automobile manufacture (i.e., a manufacturer of a different brand of automobile), and each of the Subentities associated with a Macroentity, such as by being affiliated with the Macroentity by the same intranet, is a dealer for the Macroentity, and each dealer includes different departments, such as a new vehicle department, a used vehicle department, a service department, and a parts department.

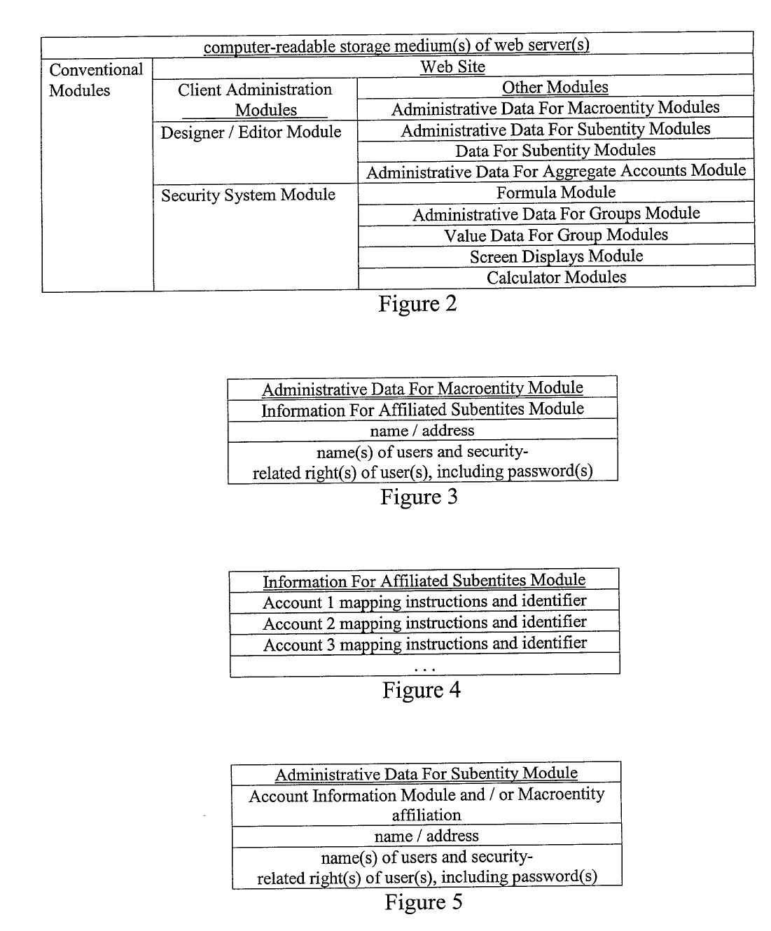

The web server 20 is conventional, except for incorporating the Web Site (FIG. 2) of the present invention. Each of the computers 20 is conventional and includes a conventional web browser for facilitating communications respectively via the intranets 24 and 28 and via the Internet 26 with the Web Site of the present invention. The intranets 24 and 28 and the Internet 26 are conventional and should be understood by those of ordinary skill in the art. For example, the Internet 26 is a network of many thousands of packet-switched networks that use the Internet protocol (TCP/IP). The Internet 26 can be briefly described in the context of end users (for example the web server 20 and the computers 22), Internet service providers (not shown), and backbone providers (not shown).

Internet service providers (ISPs) connect end users to Internet backbone networks. Backbone providers, which provide backbone networks, route traffic between ISPs and interconnect with other backbone providers. ISPs and backbone providers typically have multiple points of interconnection. Some backbone providers also serve as ISPs. Individual transmissions over the Internet 26 may be routed through multiple different providers.

The Internet 26 is a distributed, interoperable, packet-switched network. A distributed network has no one central repository of information or control, but is comprised of an interconnected web of “host” computers, each of which can be accessed from virtually any point on the network. That is, routers are positioned at connections in the network that are spread through the network, and the routers regulate the flow of data at each connection.

An interoperable network uses open protocols so that many different types of networks and facilities can be transparently linked together, and allows multiple services to be provided to different users over the same network. The Internet 26 also interconnects users of thousands of different local and regional networks, using many different types of computers. The interoperability of the Internet 26 is made possible by a previously adopted standard protocol, which is referred to as the TCP/IP protocol. The TCP/IP protocol defines a common structure for Internet data and for the routing of that data through the network.

A packet-switched network means that data transmitted over the network is split up into small chunks, or “packets.” A packet-switched network is “connectionless,” meaning that a dedicated end-to-end transmission path (or circuit) does not need to be opened for each transmission. Rather, each router calculates the best routing for a packet at a particular moment in time, given current traffic patterns, and sends the packet to the next router. When an end user sends information over the Internet 26, the data is first broken up into packets. Each of these packets includes a header which indicates the point from which the data originates and the point to which it is being sent, as well as other information.

The web server 20 illustrated in FIG. 1 can include multiple web servers that are operating together and each include one or more computer-readable storage mediums. Nonetheless, the web server 20 and its computer-readable storage medium are referred to herein as being singular, for purposes of explanation rather than for purposes of limitation. The computer-readable storage medium of the web server 20 is diagrammatically illustrated in FIG. 2 as including multiple modules (i.e., software modules), including Conventional Modules and a Web Site. The Conventional Modules are those that support conventional operational aspects of the web server 22 (FIG. 1) and the Web Site, and these conventional operational aspects are understood by those of ordinary skill in the art and are not discussed in detail herein. Whereas the first embodiment of the present invention is described in the context of the Web Site, the present invention can be embodied in other forms and is not limited to being based upon a web server or web site, or the like.

Referring to FIG. 2, The Web Site of the present invention can be characterized as including Client Administration Modules and Other Modules. The Client Administration Modules include a Designer/Editor Module containing one or more modules for designing and editing each of the Other Modules. The Client Administration Modules further include a Security System Module for advantageously restricting access to aspects of the Web Site in a manner that advantageously allows for and maintains the anonymity of each of the Subentities (FIG. 1), or at least the confidentiality of their specific data, with respect to the other Subentities of the system.

In accordance with the first embodiment of the present invention, the Security System Module maintains two basic types of security, one type of security for Macroentities and another type of security for Subentities. The Security System Module assigns special rights to an administrative person at each of the Macroentities, such as the right to access all data in the system that is associated with the Subentities affiliated with the Macroentity and the right to upload data to the Web Site. The Security System Module also allows an administrative person at each of the Subentities to set up and maintain access privileges to the Web Site for personnel located at that Subentity.

Referring to the first of the Other Modules illustrated in FIG. 2, the Web Site includes an Administrative Data For Macroentity Module for each of the Macroentities of the system, and a representative one of the Administrative Data For Macroentity Modules is diagrammatically illustrated in greater detail in FIG. 3. Referring to FIG. 3, the representative Administrative Data For Macroentity Module includes an Information For Affiliated Subentities Modules, which is partially and diagrammatically illustrated in greater detail in FIG. 4, and is discussed below with reference to FIG. 4. Referring to FIG. 3, the representative Administrative Data For Macroentity Module includes name, address and like information for its respective Macroentity; as well as security information in the form of name(s) of individuals at the Macroentity that are allowed to access the Web Site, and security-related right(s) of those user(s), including their password(s).

FIG. 4 partially and diagrammatically illustrates the Information For Affiliates Subentities Module of the representative Administrative Data For Macroentity Module of FIG. 3. Referring to FIG. 4, the Information For Affiliated Subentities Module includes information common to the Subentities affiliated with the Macroentity to which the representative Administrative Data For Macroentity Module of FIG. 3 is respectively assigned. For example, and in accordance with the first embodiment of the present invention, each of the Subentities that is affiliated with the same Macroentity has the same accounting practices such that their like Account Balances are similarly arranged in their reports. Accordingly, the Information For Affiliated Subentities Modules of the Web Site respectively provides mapping instructions and identifiers that provide for the identification and mapping of Account Balances uploaded to the Web Site, as will be discussed in greater detail below. That is, the Information For Affiliated Subentities Modules contain information for facilitating correct interpretation and placement of accounting information that is uploaded to the Web Site from the respective Macroentities. More specifically, for every record in a file uploaded from the respective Macroentity to the Web Site, the respective Information For Affiliated Subentities Modules includes means for furthering the mapping to the individual data fields of the record, so that data in the uploaded file is routed to respective specific addresses in the Data For Subentities Modules (FIG. 2) of the Web Site, where the data is stored for later use, as will be discussed in greater detail below.

Referring to FIG. 2, the Web Site can be characterized as including an Administrative Data For Subentity Module for each of the Subentities of the system, and a representative one of the Administrative Data For Subentity Modules is diagrammatically illustrated in greater detail in FIG. 5. Referring to FIG. 5, the representative Administrative Data For Subentity Module may include an Account Information Module (such as for when the Subentity is not affiliated with a Macroentity) or a pointer identifying the Macroentity with which the Subentity is affiliated. Any Account Information Module includes mapping and identifier information that is specifically for the Subentity to which the Administrative Data For Subentity Module is assigned, with the mapping and identifier information providing mapping instructions and identifiers that provide for the identification and mapping of Account Balances uploaded to the Web Site for the Subentity. If a Subentity is affiliated with a Macroentity, rather than the Administrative Data For Subentity Module including an Account Information Module, it is preferred for the Administrative Data For Subentity Module to include a pointer to the Administrative Data For Macroentity Module for the Macroentity with which the Subentity is affiliated, so that the mapping and identifier information for the Subentity can be obtained via the respective Administrative Data For Macroentity Module. That is, if a Subentity is affiliated with a Macroentity, then the Administrative Data For Subentity Module for that Subentity includes a pointer to the Administrative Data For Macroentity Module of the respective Macroentity so that pertinent information, such as mapping information for the Subentity, is gained via access to the pointed to Administrative Data For Macroentity Module. Referring to FIG. 5, the representative Administrative Data For Subentity Module further includes name, address, store number, phone number and like information for its respective Subentity; as well as security information in the form of name(s) of individuals at the Subentity that are allowed to access the Web Site, and security-related right(s) of those user(s), including their password(s).

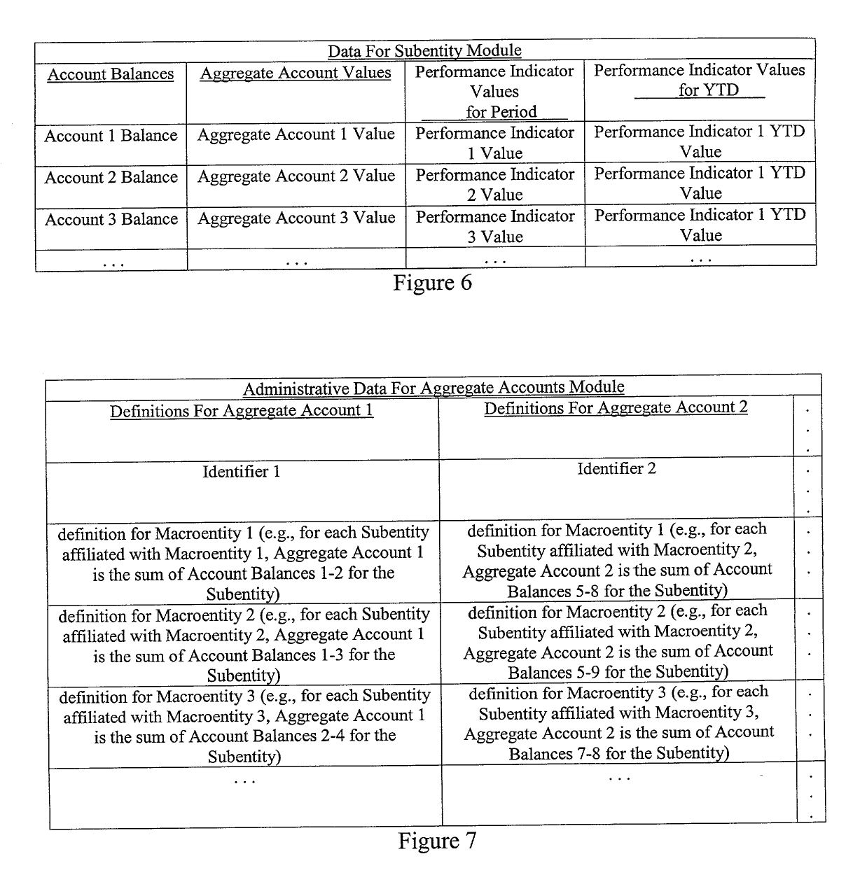

Referring to FIG. 2, the Web Site can be characterized as including a Data For Subentity Module for each of the Subentities of the system, and a representative one of the Data For Subentity Modules is partially and diagrammatically illustrated in greater detail in FIG. 6. Referring to FIG. 6, the representative Data For Subentity Module includes series of multiple Account Balances, multiple Aggregate Account Values, multiple Performance Indicator Values for the current period, and multiple Performance Indicator Year-To-Date Values. For explanatory purposes, each Data For Subentity Module, and some other modules, are described herein as being completely filled with data; however, in some embodiments of the present invention at least some or all of the calculations described herein are not performed until necessary for displaying the data or associated data via a screen display. That is, the modules are being described herein for purposes of explanation rather than for purposes of limitation.

The Web Site (FIG. 2) preferably receives a new set of Account Balances from the Subentities, preferably via the Macroentities, on a periodic bases, preferably monthly. The multiple Account Balances illustrated in FIG. 6 are a series of Account Balances that originated from a representative Subentity and were mapped into the representative Data For Subentity Module preferably based upon the Information For Affiliated Subentities Module (FIG. 4) of the Macroentity with which the representative Subentity is affiliated. Each of the Account Balances can be attributable to an individual aspect of a department within a Subentity, or attributed to multiple aspects spanning across multiple departments of a Subentity. The series of Aggregate Account Values, Performance Indicator Values for the current period, and Performance Indicator Year-To-Date Values are computed through operations of the Calculator Modules (FIG. 1) of the Web Site on the periodic basis. More specifically and referring to FIGS. 2 and 6, the Aggregate Account Values for each Subentity are calculated for the current period from the Account Balances of the Subentity that are for the current period, using respective ones of equations contained in the Administrative Data For Aggregate Accounts Module of the Web Site. Similarly and for each Subentity, the Performance Indicator Values and Performance Indicator Year-To-Date values are calculated using respective Equations from the Formula Module of the Web Site using Account Balances and Aggregate Account Values for the Subentity. Accordingly, the Web Site contains archives of prior Data For Subentity Modules from which data can be drawn.

Referring to FIG. 2, the Web Site can be characterized as including an Administrative Data For Aggregate Accounts Module, which is partially and diagrammatically illustrated in greater detail in FIG. 7. Referring to FIG. 7, the Administrative Data For Aggregate Accounts Module identifies multiple Aggregate Accounts. Additionally, the Administrative Data For Aggregate Accounts Module includes a separate and unique Identifier for each of the Aggregate Accounts, and these Identifiers are used in equations contained in the Formula Module (FIG. 2) of the Web Site, as will be discussed in greater detail below. Additionally, the Administrative Data For Aggregate Accounts Module includes for each Aggregate Account a separate definition for each of the Macroentities, as indicated in FIG. 7.

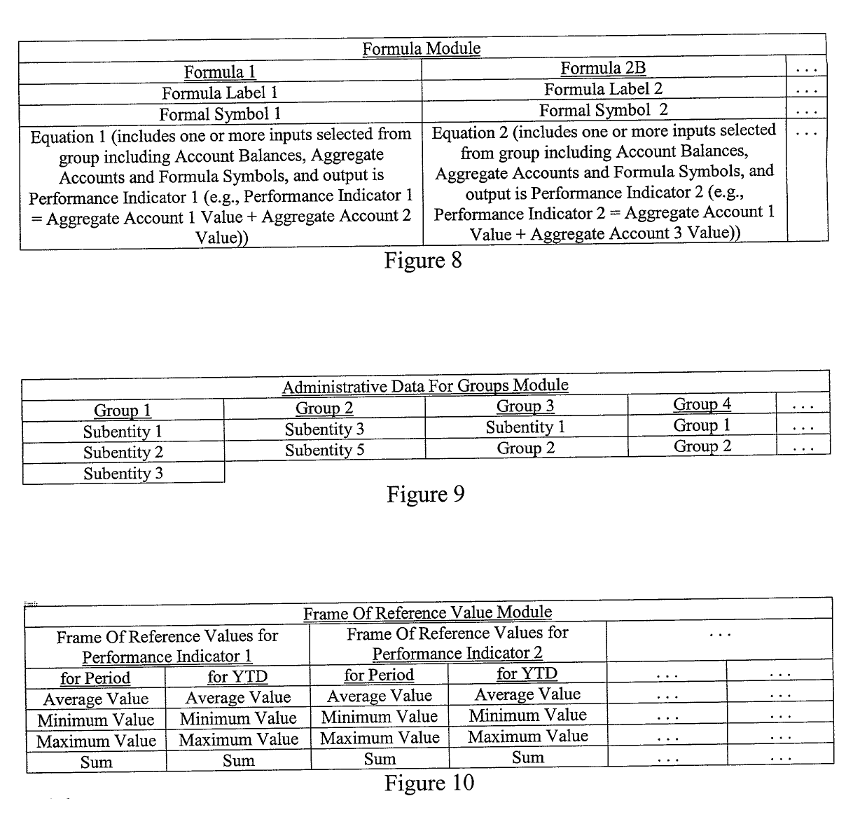

Referring to FIG. 2, the Web Site can be characterized as including a Formula Module, which is partially and diagrammatically illustrated in greater detail in FIG. 8. Referring to FIG. 8, the Formula Module identifies multiple Formulas. Additionally, the Formula Module includes separate and unique Formula Labels and Formula Symbols for each of the Formulas. Each Formula further has associated therewith a unique Equation. Each Equation includes one or more inputs selected from the group including Account Balances and Aggregate Account Values, which are respectively contained by the Data for Subentity Modules, and Formula Symbols. When a Formula Symbol is embedded in a subject Equation, it in general terms means that the Equation identified by that Formula Symbol is imbedded in the subject Equation. In accordance with the first embodiment of the present invention, the output or calculated value of each Equation is a Performance Indicator, such as sales, gross profit, expenses, net profit, personnel expenses as percentage of sales, or the like, or a raw number, such as a dollar value or a decimal number, or the like.

Further regarding each Formula, its associated Formula Symbol can be used when a display screen is being designed by placing the Formula Symbol in the display screen to indicate that the Performance Indicator calculated by the Formula is to be displayed on the display screen. Additionally and for each Formula, its Formula Label provides information about the Formula and may or may not be displayed in the display screens.

Referring to FIG. 2, the Web Site can be characterized as including an Administrative Data For Groups Module, which is partially and diagrammatically illustrated in greater detail in FIG. 9. Referring to FIG. 9, the Administrative Data For Groups Module identifies the membership of multiple Groups. For example, Group 1 includes Subentities 1-3; Group 2 includes Subentities 3 and 5; Group 3 includes Subentity 1 and Group 2, which means that Group 3 includes Subentities 1, 2 and 5; and Group 4 includes Groups 1 and 2, meaning that Group 4 includes Subentities 1-3 and Subentity 5. In accordance with one example of the present invention, for a subject Group that solely contains other Groups, the Performance Indicator Values for the subject Group are averages of the respective Performance Indicator Values of the Subentites that are ultimately members of the subject Group.

Subentities that are the member of the same group preferably share at least one common operating characteristic, such as a sales category, but more likely share most or all of the same operating characteristics and reside in the same or similar markets. As illustrated in FIG. 9, a Subentity can be a member one or more of the Groups. A user of the Web Site with appropriate access can easily add a Subentity to or remove a Subentity from a Group by using drag-and-drop functionality of the Web Site. Additionally, and as illustrated in FIG. 9 with respect to Group 4, multiple Groups can be combined to define a single Group. Additionally, the aggregate performance of one of the Groups can be compared to the aggregate performance of another of the Groups.

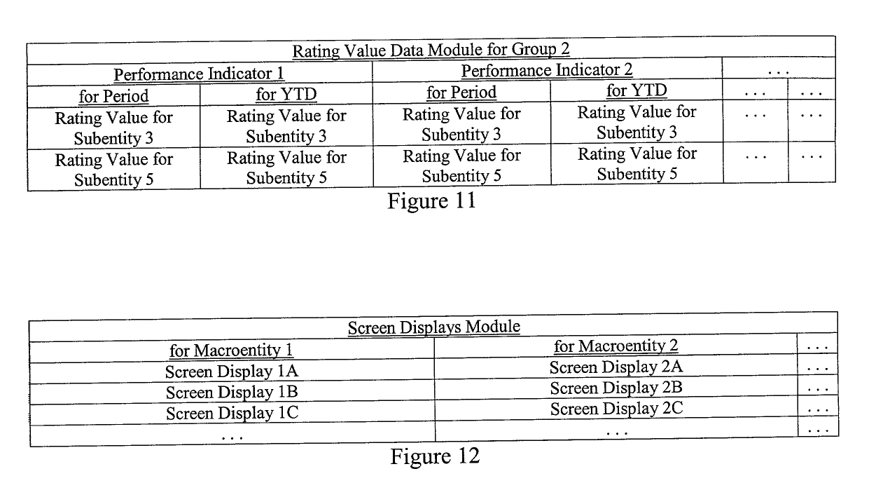

Referring to FIG. 2, the Value Data For Group Modules of the Web Site can be characterized as including both a Frame Of Reference Value Module and a Rating Value Data Module for each Group. Accordingly, a representative Frame Of Reference Value Module is partially and diagrammatically illustrated in FIG. 10, and a portion of a representative Rating Value Data Module for Group 2 is partially and diagrammatically illustrated in FIG. 11.

The representative Frame Of Reference Value Module of FIG. 10 is for a single one of the Groups. The representative Frame Of Reference Value Module includes average, minimum, maximum, and sum values for each of the Performance Indicators, with the values contained by the Frame Of Reference Value Module being determined from the respective Performance Indicator Values (FIG. 6) and/or Account Balances (FIG. 6) of the Subentities that are members of the Group. In accordance with the first embodiment of the present invention, the values of the Frame Of Reference Value Module serve as a mathematical frame of references that is based upon historical data. Notwithstanding, is within the scope of the present invention to establish the mathematical frame of reference by establishing a frequency distribution and/or a statistical measure of central tendency and/or a spread between lowest and highest data values, or the like.

Referring to FIG. 11, the representative Rating Value Data Module for Group 2 includes, for each Performance Indicator, Rating Values for each Subentity that is a member of the Group, for both the current period and year-to-date. In accordance with the first embodiment of the present invention, the Rating Value for each Subentity is determined by calculating for the Subentity's Group the spread between the Minimum and Maximum Values (FIG. 10) for the respective Performance Indicator and period, and determining the percentage range within the spread in which the respective Performance Indicator Value (FIG. 6) for the Subentity falls. Notwithstanding, it is within the scope of the present invention to establish Rating Values based on rank within the respective Group and/or by establishing a measure of difference between a Performance Indicator for a Subentity and a statistical measure of central tendency for that Performance Indicator for the Subentity's Group, or the like

Referring to FIG. 2, the Web Site further includes a Screen Displays Module that is partially and diagrammatically illustrated in greater detail in FIG. 12. Referring to FIG. 12, the Screen Display Module includes separate Screen Displays, which can more specifically be characterized as web pages and that include report formats, or the like, for each of the Macroentities. That is and in accordance with the first embodiment of the present invention, while a Subentity is accessing the Web Site, it will have access solely to screen displays developed for or appointed to the Macroentity with which the Subentity is affiliated. Separate sets of screen displays can be custom designed and maintained for each Macroentity, and it is those screens that are used for the Subentities respectively affiliated with the Macroentity. In accordance with an alternative embodiment of the present invention, means are provided for providing customized/different screens for each of the Subentities that is affiliated with a Macroentity.

### Uploading Data to Web Server

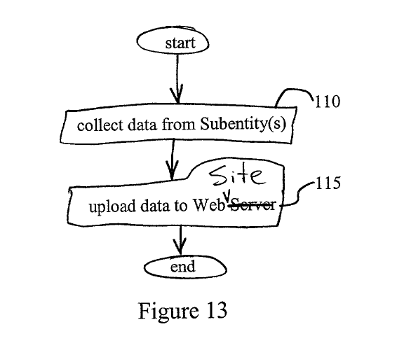

FIG. 13 is a flow chart illustrating operations performed by a Macroentity of FIG. 1 for collecting Account Balances from multiple Subentities of FIG. 1 and uploading the Account Balances to the Web Site of FIG. 2, in accordance with the first embodiment of the present invention. The Macroentity collects the Account Balances periodically, such as monthly, and FIG. 13 illustrates the operations associated with a single one of the periods. Referring to FIGS. 1 and 13, each time after the predetermined period of time passes, the Macroentity collects Account Balances from the Subentities that are affiliated with that Macroentity via an intranet, such as intranet 24 or 28, as indicated by block 110 of FIG. 13. The Account Balances may be collected by the Macroentity by virtue of the Subentities sending their Account Balances to the Macroentity via the respective intranet. Thereafter and in accordance with the first embodiment of the present invention, the Macroentity organizes the data records, which contain the Account Balances, into a large, comma-delineated spreadsheet file. Thereafter, that spreadsheet file is uploaded from the Macroentity to the Web Site (FIG. 2) on the web server 20 via the Internet 24, as illustrated by block 115. Alternatively, the data records are sent directly from the Subentities to the Web Site on the web server 20 via the Internet 24. Alternatively, the Macroentities can obtain the data from the Subentites by means other than the intranets.

### Processing Data at Web Server

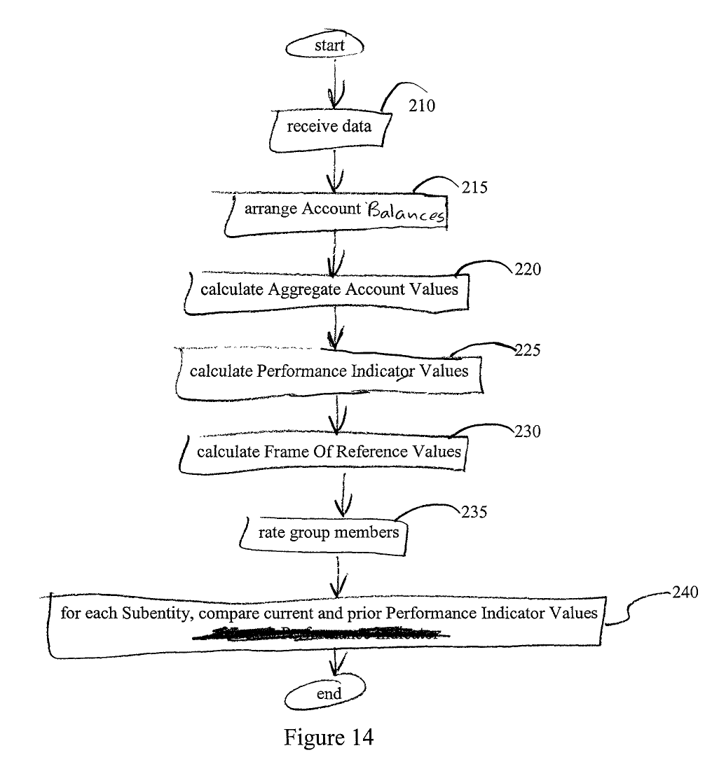

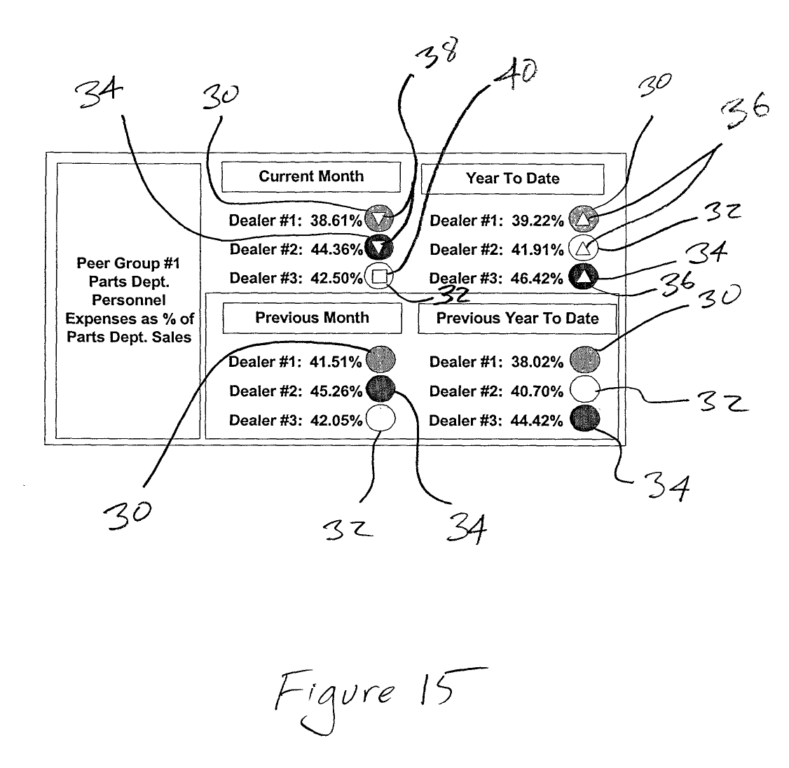

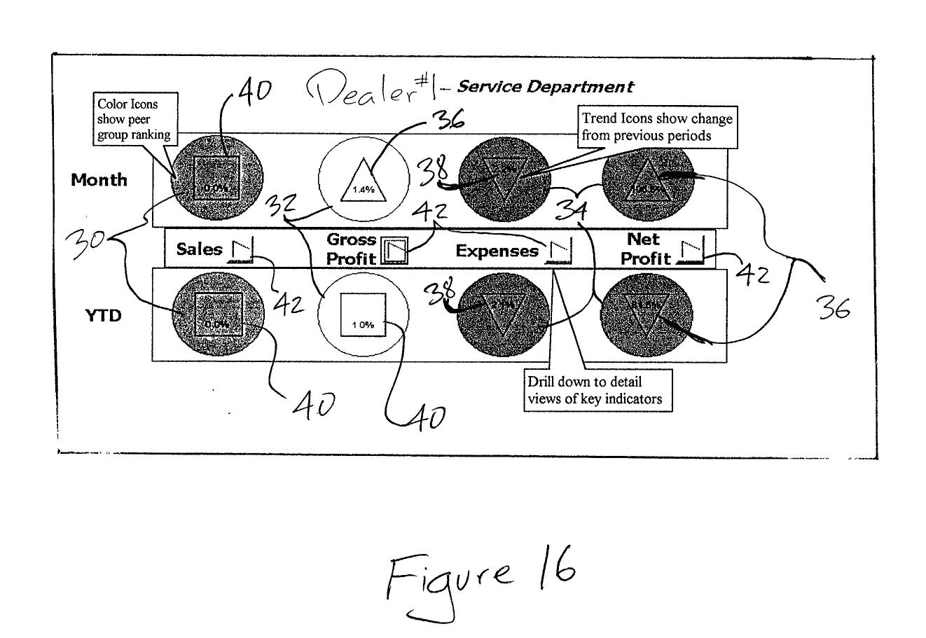

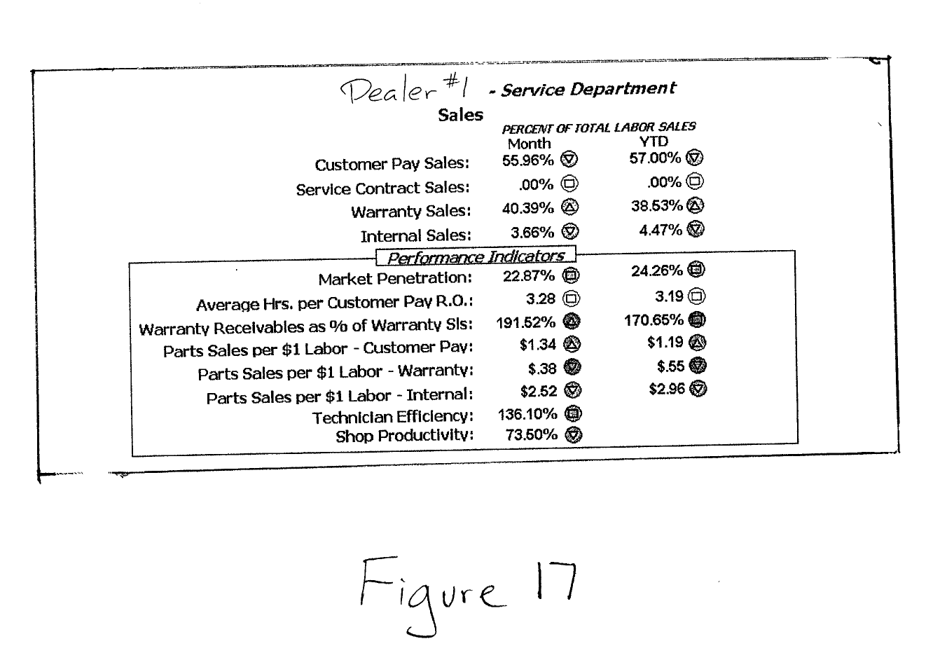

FIG. 14 is a flow chart illustrating operations performed at the Web Site (FIG. 2), such as operations for populating the Data For Subentities Modules (FIG. 2) and the Value Data For Groups Modules (FIG. 2) of the Web Site, in accordance with the first embodiment of the present invention, and these operations can be characterized as being controlled by the Calculator Modules (FIG. 2) of the Web Site. A majority of the operations illustrated in FIG. 14 are performed periodically, such as monthly, and FIG. 14 illustrates the operations associated with a single one of the periods.

The data uploaded at step 115 (FIG. 13), which includes the Account Balances (FIG. 6) for Subentity(s), is received at the Web Site at Step 210. At Step 215, respective mapping instructions, such as those diagrammatically illustrated in the Information For Affiliated Subentities Module (FIG. 4), are utilized so that Account Balances originating from multiple Subentities are appropriately segregated into respective Data For Subentity Modules (FIG. 6) and arranged so that they can be individually subsequently retrieved and utilized. More specifically and according to one example, the spreadsheet file uploaded at step 115 is separated into records at step 215, with the records being arranged and stored so that the data therein can be subsequently retrieved and used. An aspect of the Designer/Editor Module (FIG. 2) can be used to edit and correct any data (such as Account Balances) in any of the Data For Subentity Modules, if the data is damaged or becomes inaccurate due to or during the uploading process, or otherwise.

For each Subentity, after its Account Balances have been received by the Web Site at block 210 and respectively stored at block 215, the Aggregate Account Values (FIG. 6) are calculated for the Subentity and respectively stored in the respective Data For Subentity Module (FIG. 6) at block 220. For each Subentity, the Aggregate Account Values are calculated from the Subentity's respective Account Balances according to the respective definitions provided in the Administrative Data For Aggregate Accounts Module (FIG. 7) for the Macroentity with which the Subentity is affiliated. The resulting Aggregate Account Values are respectively segregated into the Data For Subentity Modules so that they can be subsequently retrieved and used.

For each Subentity, after its Aggregate Account Values have been calculated at block 220, the Performance Indicator Values both for the current period and year-to-date (FIG. 6) are calculated for the Subentity and respectively stored in the respective Data For Subentity Module (FIG. 6) at block 225. For each Subentity, each of the Performance Indicator Values is calculated from the Subentity's respective Account Balances and/or Aggregate Account Values according to the Equations respectively provided in the Formula Module (FIG. 8). That is, and referring to Equation 1 illustrated in FIG. 8 for example, when Performance Indicator 1 is calculated from Equation 1 for Subentity 1, the Aggregate Account 1 Value and Aggregate Account 2 Value utilized in the calculation are from the Data For Subentity Module for Subentity 1, whereas when Performance Indicator 1 is calculated from Equation 1 for Subentity 2, the Aggregate Account 1 Value and Aggregate Account 2 Value utilized in the calculation are from the Data For Subentity Module for Subentity 2. The resulting Performance Indicator Values are respectively segregated into the Data For Subentity Modules so that they can be subsequently retrieved and used.

At least some of the Formulas/Equations for calculating the Performance Indicator Values calculated at block 225 use Aggregate Account Values as inputs. This advantageously allows for meaningful comparisons between Performance Indicator Values of relatively dissimilar Subentities, between which comparisons of individual Account Balances would be generally meaningless due to related differences between the Subentities. That is and referring to FIG. 7 for example, by virtue of the “same” Aggregate Account being defined differently for different Macroentities and therefore their respective Subentities, comparisons can be meaningfully made between Performance Indicators of different Subentities, without the Performance Indicators having to be summations of all of the Account Balances for the Subentities. That is, the present invention advantageously uses the Aggregate Accounts and Formulas in a manner that allows for meaningful comparisons between groupings of the Account Balances of relatively dissimilar Subentities.

After all of the Performance Indicator Values for all of the Subentities have been calculated at block 225, the Frame Of Reference Values (FIG. 10) both for the current period and year-to-date are calculated for each Group and respectively stored in the respective Frame Of Reference Value Module at block 230. For each Group, each of the Frame Of Reference Values is calculated from the respective Performance Indicator Values (FIG. 6) of the Subentities belonging to the Group, with those Performance Indicator Values being obtained from the respective Data For Subentity Modules (FIG. 6). In accordance with the first embodiment of the present invention and referring to FIG. 10, for a representative Group and Performance Indicator, the Average Value is the average of the respective Performance Indicator Values for the Group, the Minimum Value is the lowest of the respective Performance Indicator Values for the Group, the Maximum Value is the highest of the respective Performance Indicator Values for the Group, and the Sum is the sum of the respective Performance Indicator Values for the Group.

After all of the Frame Of Reference Values have been calculated at block 230, the Rating Values (FIG. 11) both for the current period and year-to-date are calculated for the for each Group, or more specifically for each Subentity within each Group, and those values are respectively stored in the Rating Value Data Modules at block 235.

After the Performance Indicator Values are calculated for a Subentity at block 225, for that Subentity and for each Performance Indicator or a selected one of the Performance Indicators, the Performance Indicator Value for the current period and the Performance Indicator Value for the prior period are compared to determine whether the trend between the two periods is upward, downward, or statistically insignificant at block 240.

Referring back to block 235 and in accordance with one example of the present invention, the present invention advantageously provides for meaningful comparisons between different brands. That is and in accordance with the first embodiment of the present invention, the comparisons or ratings made at block 235 can be made between relatively different Subentities because of the usage of the Aggregate Account Values when calculating the Performance Indicator Values. As one specific example of the first embodiment of the present invention, each Macroentity represents a different automobile brand and each of the Subentities for the different brands has operating characteristics that make the Subentities of different brands somewhat unique from an accounting standpoint. For example, the Subentities associated with Macroentity 1 (e.g. Brand A) sell several different models of Brand A's cars, whereas Subentities associated with Macroentity 2 (e.g., Brand B) sell several different models of Brand B's cars. So that meaningful comparisons can be made across these different and other brands, different Account Balances are assigned to the “same” Aggregate Accounts for different brands, as generally illustrated in FIG. 7.

### Exemplary Operations

Exemplary operations of calculating Aggregate Account Values and Performance Indicator Values will now be described, in accordance with one example of the first embodiment of the present invention. In accordance with this example, by definition a Aggregate Account 3/a Parts Department Personnel Expense Aggregate Account is defined as being the sum of department personnel expenses at an automotive dealership. In accordance with this example, for Macroentity 1, which sells a first brand of automobiles, Aggregate Account 3 (i.e., the Parts Department Personnel Expense Aggregate Account) is the sum of management salaries in the parts department (which is the Account 1 Balance for Subentities affiliated with Macroentity 1), sales persons' salaries in the parts department (which is the Account 2 Balance for Subentities affiliated with Macroentity 1), vacation pay for the parts department (which is the Account 3 Balance for Subentities affiliated with Macroentity 1), uniform expenses for the parts department (which is the Account 4 Balance for Subentities affiliated with Macroentity 1), pension fund expenses for the parts department (which is the Account 5 Balance for Subentities affiliated with Macroentity 1), and clerical salaries for the parts department (which is the Account 6 Balance for Subentities affiliated with Macroentity 1). In contrast and further in accordance with this example, for Macroentity 2, which sells a second brand of automobiles that is different from the first brand, Aggregate Account 1 is the sum of management salaries in the parts department (which is the Account 1 Balance for Subentities affiliated with Macroentity 2), sales persons' salaries in the parts department (which is the Account 2 Balance for Subentities affiliated with Macroentity 2), vacation pay for the parts department (which is the Account 3 Balance for Subentities affiliated with Macroentity 2), pension fund expenses for the parts department (which is the Account 5 Balance for Subentities affiliated with Macroentity 2), and clerical salaries for the parts department (which is the Account 6 Balance for Subentities affiliated with Macroentity 2).

In accordance with this example, one of the Formulas of the Formula Module (FIG. 8), or more specifically the Equation for this Formula, is for calculating a Performance Indicator referred to as Parts Department Personnel Expenses As A Percentage Of Parts Department Gross Profit, with the Equation being equal to the Parts Department Personnel Expense Aggregate Account (i.e., Aggregate Account 3) divided by a Parts Department Gross Profit Aggregate Account. Accordingly, when this Formula/Equation is calculated for a first Subentity affiliated with Macroentity 1, which is the first brand, the Aggregate Account 3 Value for the first Subentity, which was calculated according to the definition of Aggregate Account 3 for Macroentity 1, is used; whereas when this Formula/Equation is calculated for a second Subentity affiliated with Macroentity 2, which is the second brand, the Aggregate Account 3 Value for the second Subentity, which was calculated according to the definition of Aggregate Account 3 for Macroentity 2, is used.

### Exemplary Screen Displays

Each of the screen displays of FIGS. 15-20 is a web page of the Web Site (FIG. 2) that is downloaded via the Internet 26 (FIG. 1) to one of the computers 22 (FIG. 1) and displayed on the monitor of that computer in response to the user of the computer operating the web browser of the computer to interact with and select options from a graphical user interface of the Web Site, in accordance with the first embodiment of the present invention.

FIG. 15 illustrates a portion of a screen display that presents Performance Indicator Values (i.e., the numerical percentage values illustrated in FIG. 15) for each of the Subentities that belong to a selected one of the Groups, with the screen display also presenting rating indicators or icons 30, 32 and 34 and trend indicators or icons 36, 38 and 40 for the Subentities of the selected Group, in accordance with a first example of the first embodiment of the present invention. In FIG. 15, the identified Subentities are members of a group of automotive dealerships, namely, Dealers 1-3. For each dealer for each of the current month, year-to-date, previous month and previous year-to-date, their Parts Department Personnel Expenses As Percent Of Parts Department Sales Performance Indicator Values are calculated according to block 225 of FIG. 14 and displayed in the screen display of FIG. 15. Additionally and for each of the dealers of the Group, their ratings within the Group are determined according to block 235 of FIG. 14. More specifically according to the example illustrated by FIG. 15 and regarding a selected Performance indicator, if a dealer's Performance Indicator falls into the highest third of the spread of the Performance Indictor Values for the selected Group, a green rating icon 30 is associated with the dealer: if the dealer's Selected Performance Indicator Value falls into the middle third of the spread, a yellow rating icon 32 is associated with the dealer; and if the dealer's Selected Performance Indicator Value falls into the lowest third of the spread, a red indicator icon 34 is associated with the dealer. Additionally, overlaying some of the colored indicator icons 30, 32, 34 is a trend indicator or icon 36, 38 or 40 indicating the trend, for the respective Performance Indicator and Subentity, calculated at block 240 of FIG. 14, namely a triangular indicator icon pointing up 36, a triangular indication icon pointing down 38, or a square indicator icon 40 for respectively indicating that the dealer's performance is higher, lower, or statistically even (less than a one percent change) with its own performance in the previous period.

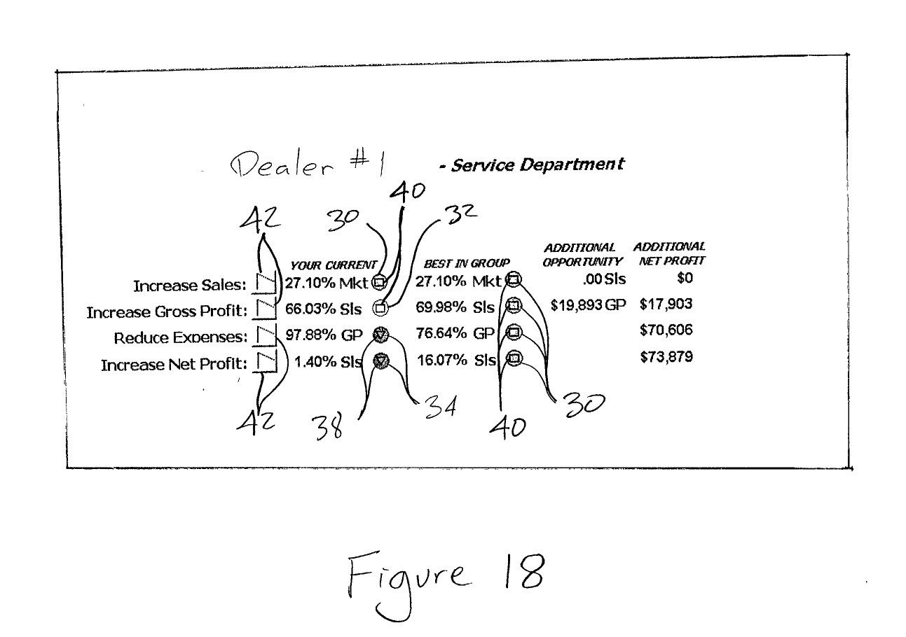

FIG. 16 illustrates a portion of a screen display that presents multiple Trend Values and Rating Values for multiple Performance Indicators for a single selected Subentity (i.e., for a department within an automobile dealership). In accordance with the first embodiment of the present invention and the example illustrated in FIG. 16, the Rating Values are displayed in the form of colored rating icons 30, 32 and 34, and Trend Indicators are displayed in the form of trend icons 36, 38 and 40 for each of the Performance Indicators. It is also within the scope of the present invention for the Rating Values and Trend Indicators to take forms other than the icons illustrated in FIG. 16.

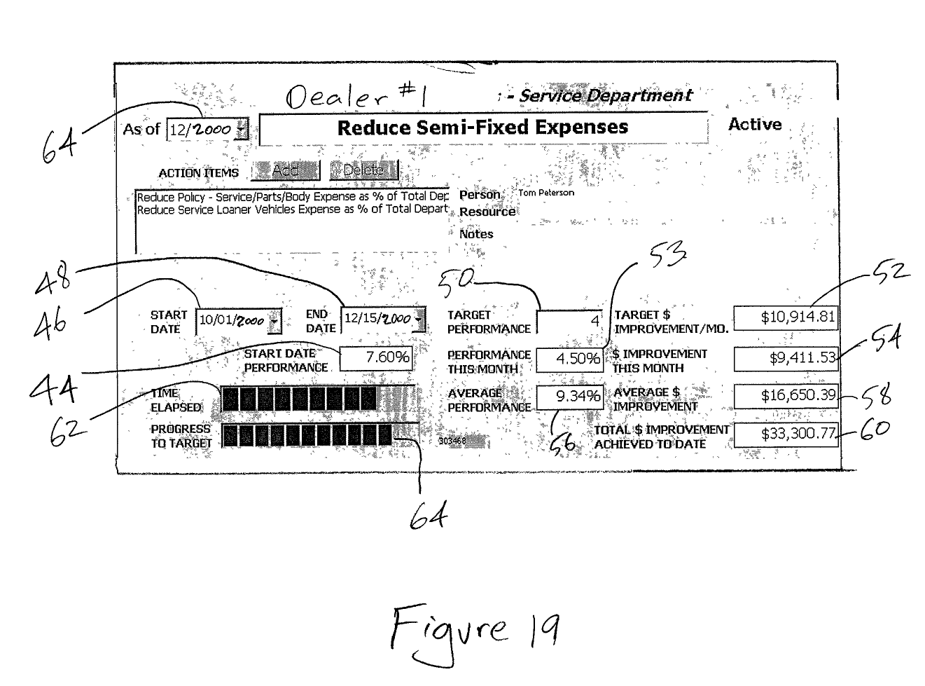

As illustrated in FIG. 16, each of the trend icons 36, 38 and 40 bounds the respective numerical Trend Value associated therewith. For each of the Performance Indicators (e.g., sales, gross profit, expenses and net profit) a respective selectable button-like icon 42 is provided. For each of the Performance Indicators, in response to a user's selection of its associated button-like icon 42 the screen display of FIG. 16 is replaced with a more specific screen display, such as the screen display of FIG. 17 when the selectable button-like icon 42 associated with the “sales” Performance Indicator of FIG. 16 is selected.

FIG. 17 diagrammatically illustrates a screen display that presents more specific sales-related Performance Indicator Values for the same Subentity as in FIG. 16, with the screen display also presenting rating icons 30, 32 and 34 (which are not identified by their respective numeral in FIG. 17 in an effort to more clearly show the screen display) and trend indicator icons 36, 38 and 40 (which are not identified by their respective numeral in FIG. 17 in an effort to more clearly show the screen display) for each of the presented Performance Indicator Values, in accordance with the second example of the first embodiment of the present invention.

FIG. 18 illustrates a portion of a screen display that presents opportunity information, namely multiple Performance Indicator Values for a Group of the Subentities, with like Performance Indicator Values arranged in each of the rows, one of the columns including Performance Indicator Values for a selected Subentity of the Group, another of the columns including the highest Performance Indicator Values of the Group, and other of the columns indicating the dollar values for the selected Subentity performing at the highest Performance Indicator Values of the Group, in accordance with the second example of the first embodiment of the present invention. The screen display of FIG. 18 also includes rating icons 30, 32 and 34 and trend indicator icons 38 and 40, as well as respective selectable button-like icons 42 that can be selected to transition to more specific display screens (not shown). Referring to FIG. 18 more specifically, each “category” shown is associated with a Performance Indicator, for example, the “Increase Sales” category is associated with a “Market Share” Performance Indicator, the “Increase Gross Profit” category is associated with the “Total Department Gross Profit as % of Total Department Sales” Performance Indicator, the “Expenses” category is associated with the “Total Department Expenses as % of Total Department Gross Profit” Performance Indicator, and the “Net Profit” category is associated with the “Operating Profit or Loss as % of Total Department Sales” Performance Indicator.

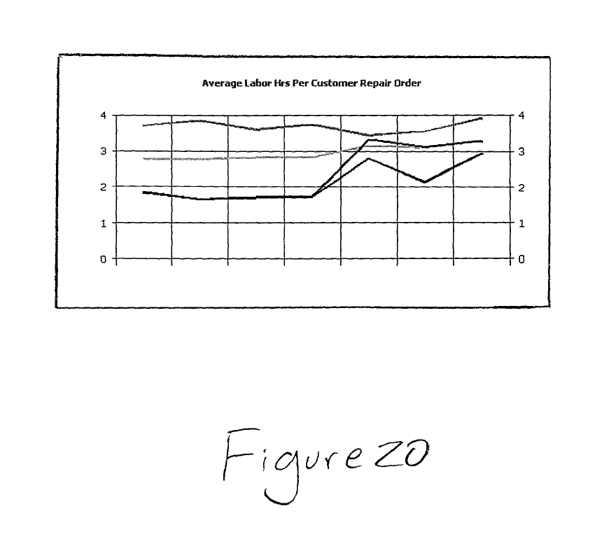

FIG. 19 diagrammatically illustrates a portion of a screen display presenting business plan information, in accordance with the second example of the first embodiment of the present invention. Regarding the screen display of FIG. 19 more specifically, it enables users at a Subentity to choose from any of their Performance Indicators, or selected combinations of similar Performance Indicators (such as expenses), and the Web Site (FIG. 2) provides automatic tracking to report the changes in the value of the selected Performance Indicator over time, with the progress being shown by an updated version of the screen display of FIG. 19. The Performance Indicator(s) to be tracked are selected from a list of Performance Indicator Names (including main Indicator Values (e.g., Expenses), sub-Indicator Values (e.g. Personnel Expenses), sub-sub-Indicator Values (e.g., Service Loaner Car Expense)). In response to the user selecting one of the Performance Indicators, the Performance Indicator Value for that Performance Indicator for the most recent period is presented in the “Start Date Performance” field 44. In the illustrated example of FIG. 19, the value shown in field 44 is for Service Loaners Vehicle Expense as % of Total Dept. Gross Profit, which is equal to Service Loaner Vehicle Expense divided by Total Dept. Gross Profit.

The user next selects a date range for tracking, including a Start Date 46 and End Date 48. The user next enters a value in the Target Performance field 50. Based upon the difference between the Start Date performance and the entered Target Performance value, a mathematical formula calculates the dollar value, namely Target $ Improvement/Mo 52, of the improvement that will be achieved if the value entered in the Target Performance field 50 is reached, based on the current reporting-period value of a separately calculated Dollar Factor keyed to the selected Performance Indicator. The Dollar Factor is normally the value derived from the denominator of the selected Performance Indicator's Formula. In the Example illustrated in FIG. 19, in which the Semi-Fixed Expenses as a Percent of Total Department Gross Profit Performance Indicator is being tracked, the difference between Start Date Performance and Target Performance is 3.6%, and the current value for Total Dept. Gross Profit is $303,189, then the Target $ Improvement/Mo. will be $10,914.81. Although the goal remains constant (until reset by the user), the changing nature of the Dollar Factor's value (it is recalculated at each successive reporting period) requires the Target $ Improvement/Mo. value to be revised and updated to match current period data.

After the close of each successive reporting period, new updated values are calculated and presented by the screen display of FIG. 19. The Performance This Month field 53 provides the value of the tracked Performance Indicator(s) for the current period. The $ Improvement This Month field 54 presents a value from a formula that takes the difference between the Start Date Performance value and Performance This Month value, and multiplies by the Dollar Factor (denominator) for the current reporting period. The Average Performance field 56 presents a value from a formula that derives a value representing the average of the Performance This Month values between the Start Date reporting period and the current reporting period. The Average $ Improvement field 58 presents a value from a formula that derives a value representing the average of the $ Improvement This Month values between the Start Date reporting period and the current reporting period. The Total $ Improvement Achieved to Date field 60 presents a value from a formula that calculates the sum of the $ Improvement This Month values between the Start Date reporting period and the current reporting period. A Time Elapsed indicator 62 displays a horizontal bar populated with colored blocks representing the percentage of time “used” in the date range indicated by the Start Date 46 and End Date 48, indicating also the amount of time remaining before the End Date of the plan. A Progress to Target indicator 64 displays a horizontal bar populated with colored blocks representing the Target Performance value divided by the Performance This Month value, indicating also the amount of unrealized improvement remaining between the Performance This Month value and the Target Performance value. Users can use the As Of field 64, which is a date field, to recreate what-if scenarios using historical data. This resets the current reporting period values to those of the date chosen in the As Of field 64.

Users can save their Business Plans, one of which is diagrammatically illustrated by the screen display of FIG. 19, by name, and access them through a scroll list. In accordance with the fist embodiment of the present invention, the system continues tracking the Business Plans each reporting period, ending when the End Date 48 is reached.

FIG. 20 illustrates a portion of a screen display that graphically trends Frame Of Reference Values for a Group of Subentities against the corresponding Performance Indicator Values of a selected Subentity of the Group, in accordance with a third example of the first embodiment of the present invention.

### Block Diagrams Flowcharts and Control Flows

The FIGS. 1-19 are illustrative of block diagram, flowchart, control flow and other illustrations of methods, systems and program products according to the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus create means or devices for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means or devices which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means or devices for performing the specified functions, combinations of steps for performing the specified functions and program instruction means or devices for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for comparing the performance of business entities, the method comprising the operations of:
establishing a mathematical frame of reference that is based upon historical data for at least both first and second entities of a plurality of entities;
determining a rating value based upon the mathematical frame of reference and data for the first entity; and
presenting the rating value to the first entity without disclosing the data for the second entity to the first entity.

2. A method according to claim 1, wherein the operation of presenting the rating value to the first entity includes presenting the rating value in the form of a colored icon.

3. A method according to claim 1, further comprising determining performance indicator values that are related to the rating value and presenting the performance indicator values to the first entity in response to a selection made by the first entity while the first entity was viewing the rating value.

4. A method according to claim 1, wherein the establishing operation includes obtaining a value for a performance indicator for the first entity and a value for the performance indicator for the second entity.

5. A method according to claim 4, further comprising tracking the value for the performance indicator for first entity over time.

6. A method according to claim 4, wherein the operation of obtaining a value for a performance indicator includes using the same equation for calculating the value for the performance indicator for the first entity and the value for the performance indicator for the second entity, with different groups of account balances being the inputs to the equation for the first and second entities.

7. A method according to claim 1, further comprising uploading the data to a web server via the Internet, wherein the establishing and determining operations are performed by the web server, and the presenting operation includes downloading the rating value from the web server to a computer via the Internet, and presenting a screen display, which includes the rating value, on a monitor associated with the computer.

8. A method according to claim 1, wherein the presenting operation includes disclosing the identity of the second entity to he first entity.

9. A method according to claim 1, wherein the data is for the same type of goods or services.

10. A method according to claim 1, wherein the data is selected from the group consisting of sales, expenses, gross profit and net profit.

11. A method according to claim 1, wherein the establishing operation includes establishing a frame of reference selected from the group consisting of:
a frequency distribution,
a statistical measure of central tendency, and
a spread between lowest and highest data values of the data.

12. A method according to claim 1, wherein the determining operation includes determining a relationship selected from the group consisting of:
rank,
a measure of difference between data from the first entity and a statistical measure of central tendency, and
an indication of position of data from the first entity within a spread between lowest and highest data values of the data.

13. A method according to claim 1, wherein the determining operation includes ranking the data for the first entity.

14. A method according to claim 13, wherein the presenting operation includes presenting a screen display for the first entity, with the screen display including an icon that is indicative of the ranking.

15. A method according to claim 14, wherein:
the determining operation includes determining which of two or more percentage ranges that the data for the first entity falls within, with the two or more percentage ranges including a first percentage range and a second percentage range;
the icon is a first icon; and
the operation of presenting the screen display includes:
presenting the first icon in response to determining that the data for the first entity falls within the first percentage range, and
presenting a second icon, which is different from the first icon, in response to determining that the data for the first entity falls within the second percentage range.

16. A method according to claim 15, wherein the first and second icons are different colors.

17. A method according to claim 1, wherein the data for the first entity is second data for a second period, and the method further comprises the operations of:
receiving first data for a first period for the first entity, wherein the first period is prior to the second period,
quantifying a trending relationship between the first and second data, and
presenting information about the trending relationship to the first entity.

18. A method according to claim 17, wherein the presenting operations are contemporaneous.

19. A method according to claim 17, wherein the operation of presenting information about the trending relationship includes presenting a screen display for the first entity, with the screen display including a direction-indicating icon that is indicative of the trending relationship between the first and second data.

20. A method according to claim 19, wherein:
the operation of quantifying the trending relationship includes determining whether the first data is greater than or less than the second data; and
the operation of presenting the screen display includes orienting the direct-indicating icon in a first direction in response to determining that the first data is greater than the second data, and orienting the direction-indicating icon in a second direction, which is different from the first direction, in response to determining that the first data is less than the second data.

21. A method according to claim 19, wherein:
the operation of determining a rating value includes ranking the data for the first entity; and
the operation of presenting the rating value includes presenting an icon that is indicative of the ranking in the screen display so that one of the icons overlays the other of the icons.

22. A computer-readable medium having computer-executable instructions for performing the operations recited in claim 1.

23. A method of calculating values for a performance indicator for a plurality of business entities, comprising the operations of:
obtaining a first plurality of account balances for a first entity and a second plurality of account balances for a second entity;
calculating a first sum of a first group of account balances that is a subset of the first plurality of account balances, wherein the account balances of the first group encompass respective aspects of the first entity so that the first group consists of a first set of aspects;
calculating a second sum of a second group of account balances that is a subset of the second plurality of account balances, wherein the account balances of the second group encompass respective aspects of the second entity so that the second group consists of a second set of aspects, wherein the second set of aspects does not include all of the aspects included in the first set of aspects;
providing an equation that is for calculating a performance indicator and that includes a plurality of inputs;
determining a value for the performance indicator for the first entity by calculating the equation using the first sum as a first input of the inputs of the equation; and
determining a value for the performance indicator for the second entity by calculating the equation using the first sum as the first input of the equation.

24. A method according to claim 23, wherein the obtaining operation includes uploading the first and second plurality of account balances to a web server via the Internet, wherein the calculating and determining operations are performed by the web server.

25. A method according to claim 23, further comprising:
establishing a mathematical frame of reference that is at least partially based upon the value of the performance indicator for the first entity and the value of the performance indicator for the second entity;
determining a rating value based upon a relationship between the mathematical frame of reference and the value of the performance indicator for the first entity; and
presenting the rating value to the first entity without disclosing the account balances of the second entity to the first entity.

26. A method according to claim 23, wherein the second set of aspects includes a majority of the aspects included in the first set of aspects.

27. A method according to claim 23, wherein the second set of aspects is a subset of the first set of aspects.

28. A computer-readable medium having computer-executable instructions for performing the operations recited in claim 23.

29. A method of calculating values of a performance indicator for a plurality of business entities, comprising the operations of:
obtaining a first plurality of account balances for a first entity and a second plurality of account balances for a second entity;
calculating a first sum of a first group of account balances that is a subset of the first plurality of account balances, wherein the account balances of the first group respectively encompass sales of multiple models sold under a first brand;
calculating a second sum of a second group of account balances that is a subset of the second plurality of account balances, wherein the account balances of the second group respectively encompass sales of multiple models sold under a second brand, wherein the models sold under the second brand are different than the models sold under the first brand and the first brand is different from the second brand;
providing an equation that is for calculating a performance indicator and that includes a plurality of inputs;
determining a value for the performance indicator for the first entity by calculating the equation using the first sum as a first input of the inputs of the equation; and
determining a value for the performance indicator for the second entity by calculating the equation using the second sum as the first input of the equation.

30. A method according to claim 29, further comprising:
establishing a mathematical frame of reference that is at least partially based upon the value of the performance indicator for the first entity and the value of the performance indicator for the second entity;
determining a rating value based upon a relationship between the mathematical frame of reference and the value of the performance indicator for the first entity; and
presenting the rating value to the first entity without disclosing data for the second entity to the first entity.

31. A method according to claim 29, wherein the obtaining operation includes uploading the first and second plurality of account balances to a web server via the Internet, wherein the calculating and determining operations are performed by the web server.

32. A computer-readable medium having computer-executable instructions for performing the operations recited in claim 29.
